(19) United States
(12) Patent Application Publication
(10) Pub. No.: US 2010/0067155 A1
(43) Pub. Date: Mar. 18, 2010

(54) Method and apparatus for enhancing the triggering of an electrostatic discharge protection device

(75) Inventors: Antonio Gallerano, San Jose, CA (US); Jeffrey T. Watt, Palo Alto, CA (US)

Correspondence Address: LAWRENCE M. CHO, P. O. BOX 2144, CHAMPAIGN, IL, 61825, US

(73) Assignee: Altera Corporation

(21) Appl. No.: 12/283,725

(22) Filed: Sep. 15, 2008

(51) Int. Cl. H02H 9/00

(52) U.S. Cl. 361/56

(57) ABSTRACT

An electrostatic discharge (ESD) protection circuit for protecting a semiconductor device that includes a metal oxide semiconductor field effect transistor (MOSFET) providing a first path from a source of an electrostatic charge to ground. The ESD protection circuit also includes an NPN bipolar transistor providing a second path from the source of the electrostatic charge to ground. The ESD protection circuit also includes a regulation component coupled in series to a base of the NPN bipolar transistor to provide an amount of resistance when the semiconductor device is off and to provide a reduced amount of resistance when the semiconductor device is on.

### TECHNICAL FIELD

Embodiments of the present invention relate to electrostatic discharge (ESD) protection devices. More specifically, embodiments of the present invention relate to a method and apparatus for enhancing the triggering of an electrostatic discharge protection device.

### BACKGROUND

ESD is the transfer of electrostatic charge between two objects. It is a rapid event that usually results when two objects of different potentials come into contact with each other. ESD may also occur when a high electrostatic field develops between two objects in close proximity. ESD has been known to cause device failures in the semiconductor industry.

There are several industry-standard ESD models that define how semiconductor devices are tested for ESD sensitivity under different situations of electrostatic build-up and discharge. For example, the human body model (HBM) simulates the ESD phenomenon where a charged body directly transfers its accumulated electrostatic charge to an ESD-sensitive device. The machine model (MM) simulates a more rapid and severe electrostatic discharge from a charged machine, fixture, or tool to the ESD-sensitive device at a different potential. The charged device model (CDM) simulates a transfer of accumulated electrostatic charge from a charged device to another body of different potential.

Traditional ESD protection devices included transistor snapback based circuits. Transistor snapback based circuits make use of the snapback triggering characteristics of a parasitic bipolar structure switching into high conductivity once a critical voltage level (breakdown voltage) is developed between drain and source. A common characteristic of snapback based protection elements is non uniform bipolar triggering. Increasing the size of the protection element was not an effective solution since current crowding limited the effective width used to dissipate the ESD event to a value that was substantially less than the nominal device width. Moreover, increasing the ESD device width came at the expenses of larger die size and higher pin capacitance.

### SUMMARY

According to an embodiment of the present invention, an electrostatic discharge (ESD) protection circuit for protecting a device is disclosed. The ESD protection circuit includes a metal oxide semiconductor field effect transistor (MOSFET) providing a first path from a source of an electrostatic charge to ground. The ESD protection circuit includes an NPN bipolar transistor providing a second path from the source of the electrostatic charge to ground. The operation of the NPN bipolar transistor is enhanced by connecting a regulation component in series to a base of the NPN bipolar transistor. The regulation component adds an amount of resistance between the base and Vss during an ESD event. This allows a large voltage to form between the base and emitter of the NPN bipolar transistor during the ESD event and for the NPN bipolar transistor to turn on. The regulation component provides a reduced amount of resistance between the base and Vss when the device is on and when there is no ESD event. This allows the regular operation of the device, including its switching characteristic, to be maintained.

### BRIEF DESCRIPTION OF THE DRAWINGS

The features and advantages of the present invention are illustrated by way of example and are by no means intended to limit the scope of the present invention to the particular embodiments shown.

FIG. 1 illustrates a device on which an electrostatic discharge (ESD) protection circuit resides on according to an exemplary embodiment of the present invention.

FIG. 2A illustrates an exemplary ESD protection circuit according to an embodiment of the present invention.

FIG. 2B illustrates an ESD current path through the ESD protection circuit of FIG. 2A.

FIG. 3 is a current voltage chart that illustrates how the ESD protection circuit of FIG. 2A handles ESD current according to an embodiment of the present invention.

FIG. 4 illustrates an exemplary implementation of an ESD protection circuit with an array of circuit elements according to embodiment of the present invention.

FIG. 5 illustrates a first implementation of the ESD protection circuit of FIG. 2A according to an embodiment of the present invention.

FIG. 6 illustrates a second implementation of the ESD protection circuit of FIG. 2A according to an embodiment of the present invention.

FIG. 7 illustrates an ESD protection circuit implemented in an R-well according to an exemplary embodiment of the present invention.

FIG. 8 is a flow chart illustrating a method for managing an ESD event according to an embodiment of the present invention.

### DETAILED DESCRIPTION

In the following description, for purposes of explanation, specific nomenclature is set forth to provide a thorough understanding of embodiments of the present invention. It will be apparent to one skilled in the art that specific details in the description may not be required to practice the embodiments of the present invention. In other instances, well-known circuits, devices, and programs are shown in block diagram form to avoid obscuring embodiments of the present invention unnecessarily. Additionally, some embodiments of the invention are described in the context of field programmable gate arrays (“FPGA”), but the invention is applicable to other contexts as well, including other semiconductor devices such as programmable logic devices, complex programmable logic devices, application specific integrated circuits, processors, controllers and memory devices.

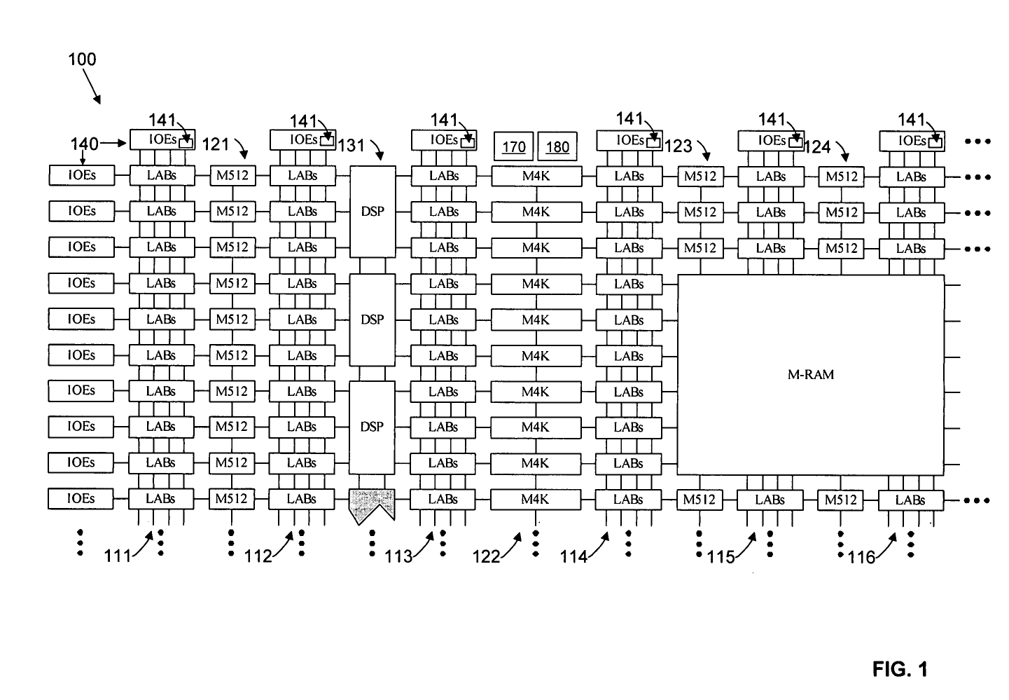

FIG. 1 illustrates a device 100 on which an electrostatic discharge (ESD) protection circuit resides according to an exemplary embodiment of the present invention. In this example, the device 100 is a target device such as an FPGA which a system may be implemented on. The target device 100 may be a semiconductor device having a hierarchical structure that may take advantage of wiring locality properties of circuits formed therein.

The target device 100 includes a plurality of logic-array blocks (LABs). Each LAB may be formed from a plurality of logic blocks, carry chains, LAB control signals, (lookup table) LUT chain, and register chain connection lines. A logic block is a small unit of logic providing efficient implementation of user logic functions. A logic block includes one or more combinational cells, where each combinational cell has a single output, and registers. According to one embodiment of the present invention, the logic block may operate similarly to a logic element (LE), such as those found in the Stratix or Cyclone devices manufactured by Altera® Corporation, or a combinational logic block (CLB) such as those found in Virtex devices manufactured by Xilinx Inc. In this embodiment, the logic block may include a four input lookup table (LUT) with a configurable register. According to an alternate embodiment of the present invention, the logic block may operate similarly to an adaptive logic module (ALM), such as those found in Stratix devices manufactured by Altera Corporation. LABs are grouped into rows and columns across the target device 100. Columns of LABs are shown as 111-116. It should be appreciated that the logic block may include additional or alternate components.

The target device 100 includes memory blocks. The memory blocks may be, for example, dual port random access memory (RAM) blocks that provide dedicated true dual-port, simple dual-port, or single port memory up to various bits wide at up to various frequencies. The memory blocks may be grouped into columns across the target device in between selected LABs or located individually or in pairs within the target device 100. Columns of memory blocks are shown as 121-124.

The target device 100 includes digital signal processing (DSP) blocks. The DSP blocks may be used to implement multipliers of various configurations with add or subtract features. The DSP blocks include shift registers, multipliers, adders, and accumulators. The DSP blocks may be grouped into columns across the target device 100 and are shown as 131.

The target device 100 includes a plurality of input/output elements (IOEs) 140. Each IOE feeds an IO pin (not shown) on the target device 100. The IOEs 140 are located at the end of LAB rows and columns around the periphery of the target device 100. Each IOE includes a bidirectional 10 buffer and a plurality of registers for registering input, output, and output-enable signals. When used with dedicated clocks, the registers provide performance and interface support with external memory devices. Each IO buffer includes an ESD protection circuit 141. Each ESD protection circuit 141 may operate to protect its corresponding IOE on the target device 100 from an ESD event. For example, if an object of higher potential comes in contact with a pin connected to an 10 buffer, the ESD protection circuit 141 may operate to provide a path to ground to prevent a voltage spike from damaging circuitry on the IOE and target device 100.

The target device 100 may include routing resources such as LAB local interconnect lines, row interconnect lines (“H-type wires”), and column interconnect lines (“V-type wires”) (not shown) to route signals between components on the target device.

FIG. 1 illustrates an exemplary embodiment of a target device. It should also be appreciated that, as indicated above, the target device may include the same or different semiconductor devices arranged in a different manner. The target device 100 may also include FPGA resources other than those described and illustrated with reference to the target device illustrated in FIG. 1. Thus, while embodiments of the invention described herein may be utilized on the architecture described in FIG. 1, it should be appreciated that it may also be utilized on different architectures.

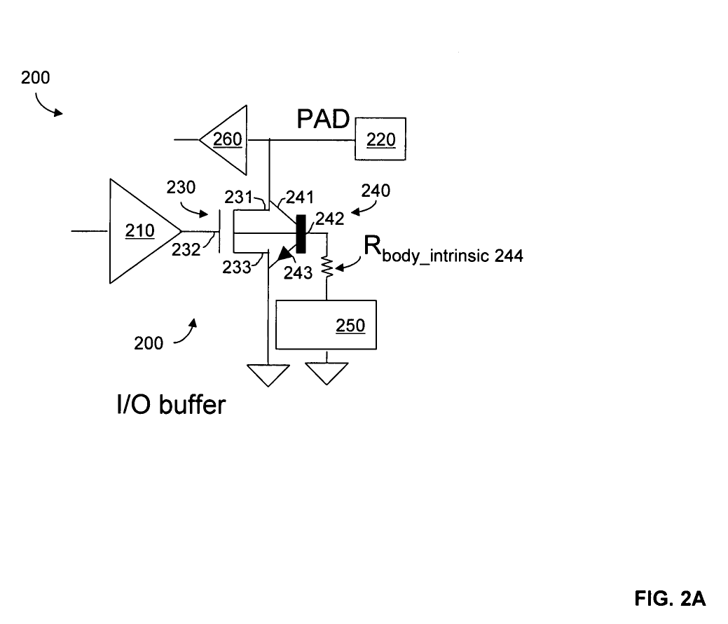

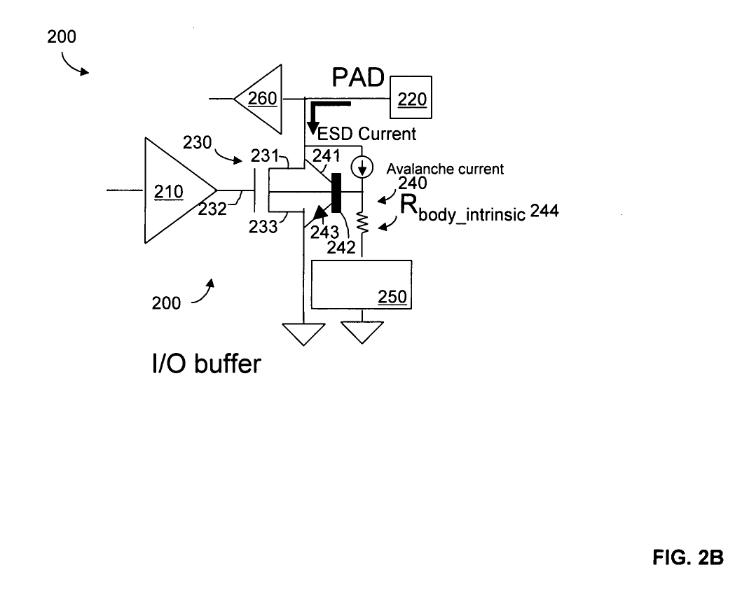

FIG. 2A illustrates an ESD protection circuit 200 according to a first embodiment of the present invention. The ESD protection circuit 200 illustrated may be used to implement portions of the ESD protection circuit 141 illustrated in FIG. 1 and function as an 10 buffer. According to an embodiment of the present invention, the ESD protection circuit 200 may be connected to 10 circuitry 210 and 260. The IO circuitry 210 and 260 may include a plurality of registers for registering output and output-enable signals, input buffers or other circuitry that the ESD protection circuit 200 is to protect.

The ESD protection circuit 200 includes a pad 220 that may be interfaced with a component to transmit or receive a signal. The ESD protection circuit 200 includes a discharge transistor 230. The discharge transistor 230 may be implemented with a MOSFET having a drain 231 connected to the pad 220, a gate 232 connected to the IO circuitry 210, and a source 233 connected to ground. The MOSFET 230 provides a first path for an ESD charge received at pad 220 to ground. The ESD protection circuit 200 includes a parasitic NPN bipolar transistor 240 that includes a collector 241 coupled to the drain of the MOSFET 230 and therefore connected to the pad 220, a base 242 that is formed from a body of the MOSFET 230, and an emitter 243 that is coupled to the source 233 of the MOSFET 230 and connected to ground. The NPN bipolar transistor 240 includes intrinsic resistance (R_{body}_{_{—}}_{intrinsic}) 244 from the base 242 (body region under the gate of the discharge transistor 230). The ESD protection circuit 200 includes a regulation component 250. The regulation component 250 is in series with the base 242 of the NPN bipolar transistor (connected to a base/body contact of the NPN bipolar transistor). The regulation component 250 is coupled to a power supply of a device and provides an amount of resistance when the device is off. The regulation component 250 also provides a reduced amount of resistance when the device is on.

FIG. 2B illustrates an ESD current path on the exemplary ESD protection circuit 200 according to an embodiment of the present invention. During an ESD event, current being pushed onto pad 220 causes the voltage at the drain 231 of MOSFET 230 to rise beyond its normal operating range. At some point, the voltage on the drain is high enough to cause a regenerative process called avalanche generation where electron hole pairs are created at the drain junction. The holes will flow into the ground through the R_{body}_{_{—}}_{intrinsic} 244 creating a positive voltage between the base 242 and emitter 243 of the NPN bipolar transistor 240. At some point, this voltage is sufficient to turn on the parasitic NPN transistor 240 which makes an alternative, second current path available in parallel with the MOSFET. This causes the voltage at the drain 231 of the MOSFET 230 to collapse.

During an ESD event, the regulation component 250 adds resistance (R_{body}_{_{—}}_{extrinsic}) which increases the voltage between the base 242 and emitter 243 (body voltage). During avalanche generation, the body voltage is kept high enough by the resistance added by the regulation component 250 so that the NPN bipolar transistor 240 would be forced on. When the device which the ESD protection circuit 200 is protecting is operating normally (when there is no ESD event), the regulation component 250 provides a short to ground which amounts to a reduced amount of resistance being close to zero or an amount that is negligible. This ensures that the regular operation of the I/O buffer, including its switching behavior, is not affected by the regulation component 250. If the body voltage is not tied to ground with a hard connection, the conductive properties of the MOSFET 230 could be modulated and transients could be distorted, which is undesirable. Thus, the regulation component 250 improves the IO buffer functionalities of the ESD protection circuit 200.

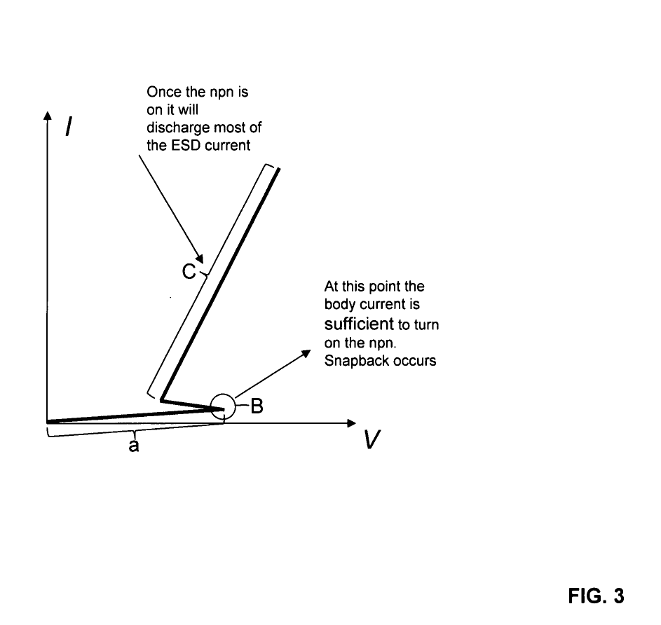

FIG. 3 is a current voltage chart that illustrates how the ESD protection circuit of FIG. 2A handles ESD current according to an embodiment of the present invention. The current voltage chart plots the ESD current along the y-axis against the amount of voltage at the drain of the MOSFET (V_{ds}) along the x-axis. During an ESD event, the MOSFET 230 (shown in FIGS. 2A and 2B) is off and in a high impedance state. The bipolar NPN transistor 240 (shown in FIGS. 2A and 2B) is also off. During this first phase, the ESD current forces the voltage at the drain of the MOSFET 230 to increase. This is plotted along segment A in FIG. 3. The voltage at the drain of the MOSFET 230 eventually reaches a point where it generates regenerative current (avalanche current) which is pushed into the body (base of the NPN transistor 240) and current flows into R_{body}_{_{—}}_{intrinsic} 244. At this point, sufficient voltage is generated between the base and emitter of the NPN bipolar transistor 240 and the bipolar is turned on. This is illustrated at point B in FIG. 3. The NPN bipolar transistor 240 is turned on, and a new path is provided to ground. This is plotted along segment C in FIG. 3.

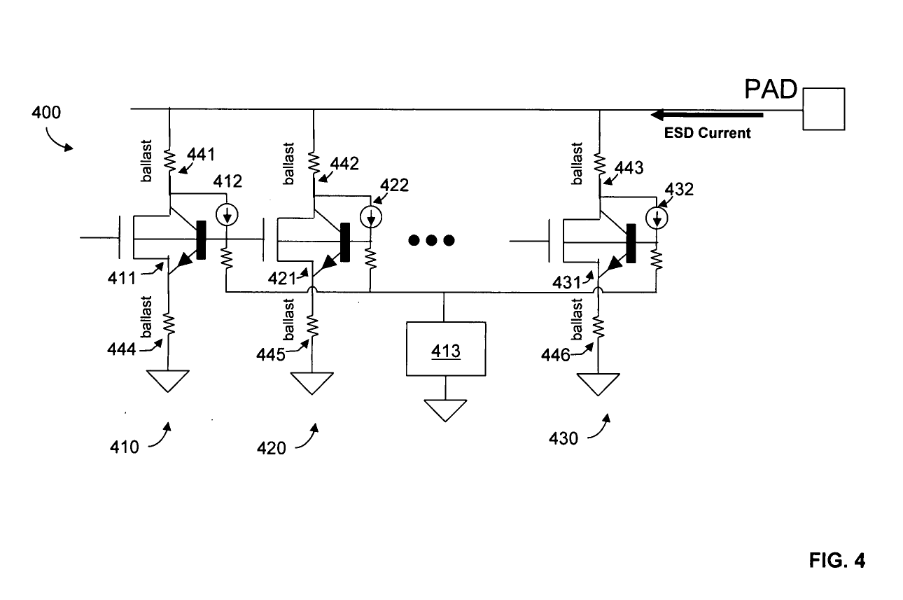

FIG. 4 illustrates an exemplary implementation of an ESD protection circuit 400 with an array of circuit elements according to embodiment of the present invention. In this embodiment, the MOSFET transistor 230 and the NPN bipolar transistor 240 of FIGS. 2A and 2B are implemented with a plurality of MOSFET transistors and NPN bipolar transistors. A typical ESD discharge current is in the order of Amps. In order to effectively absorb the energy associated with the ESD discharge current, an ESD protection circuit is required to be of sufficient size. According to one embodiment of the present invention the ESD protection circuit 200 illustrated in FIG. 2A may be implemented using an array of parallel legs/fingers as illustrated by the ESD protection circuit 400 to provide a sufficient size. The ESD protection circuit 400 includes a first leg 410 that includes a first MOSFET transistor 411 and a first NPN bipolar transistor 412 configured similarly to the ESD protection circuit 200, a second leg 420 that includes a second MOSFET transistor 421, a second NPN bipolar transistor 422 configured similarly to the ESD protection circuit 200, and an nth leg 430 that includes an nth MOSFET transistor 431, an nth NPN bipolar transistor 432 configured similarly to the ESD protection circuit 200, where n can be any number. A regulation component 413 is connected to the body tap common to each transistor.

Due to the geometry of devices during the manufacturing process, the parasitic NPN bipolar transistor of only one or a few legs may trigger at first. This lowers the voltage on the entire ESD protection circuit 400, and the remaining untriggered legs will not trigger. According to an embodiment of the ESD protection circuit 400, a plurality of ballast resistors 441-446 are implemented to increase the voltage on the drain of the MOSFETs and the bodies of the NPN bipolar transistors so that NPN triggering spreads to all of the legs of the ESD protection circuit 400. This would allow all of the legs to conduct the ESD current uniformly.

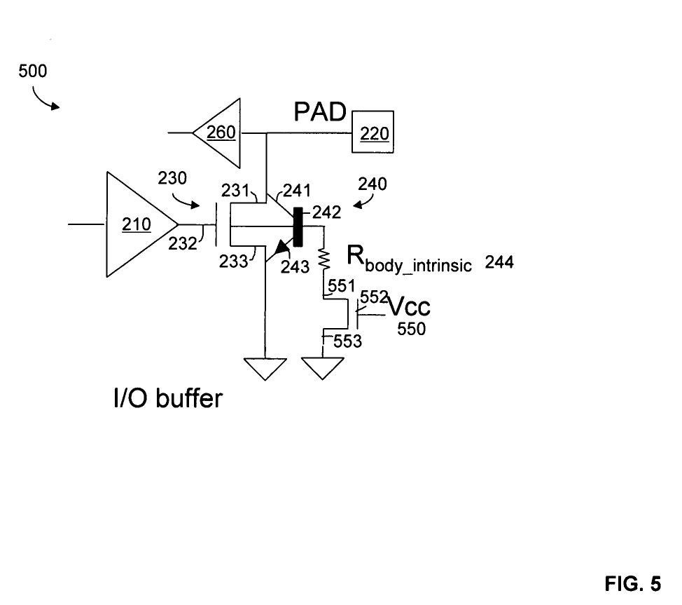

FIG. 5 illustrates a first implementation of the ESD protection circuit of FIG. 2A according to an embodiment of the present invention. The ESD protection circuit 500 includes a regulation component 550 that is implemented using an NMOS transistor (MOSFET). The MOSFET 550 includes a drain connected in series with the base of NPN bipolar transistor 240, a gate connected to power supply (Vcc), and a source connected to ground. During normal operation of a device, Vcc is powered up. Since the gate of the MOSFET 552 is tied to Vcc, the gate is high when the device is on. This has the effect of shorting the drain 551 to ground. The body voltage will therefore sit at ground so that the switching behavior of the IO buffer is unaltered. An ESD event may occur when the power to the device is off and Vcc is powered down. When Vcc is zero, the MOSFET 550 provides an open connection instead of a shorted connection to ground. The open connection provides a large amount of resistance which allows a large voltage to be generated at the body of the NPN bipolar transistor 240.

According to an embodiment of the present invention the MOSFET 550 may be implemented with a minimum gate length NMOS transistor. The MOSFET 550 may have its gate connected to a power supply that has a high capacitance to ground (large domain). According to one embodiment, the power supply is a voltage supply of the device that powers the largest number of circuits on a chip which the device resides on. When Vcc is a low voltage power supply, the MOSFET 550 may be implemented using a thin oxide transistor. This reduces the width required to hold the body close to Vss during regular operation.

If the gate 552 of MOSFET 550 is coupled to a power supply of a large power domain such as an FPGA core, its voltage will be close to Vss during an ESD event on any IO pin. According to an embodiment of the present invention, when the MOSFET 550 is as wide as 30 μm, its impedance is typically at or higher than 1 KΩ when Vcc is as high as 0.5 V. During normal operation (non-ESD event), the voltage on the gate 552 of the MOSFET 550 is Vcc. The impedance or resistance developed by a 30 μm device is about 20Ω. This can be considered negligible compared to the intrinsic body resistance (R_{body}_{_{—}}_{intrinsic}).

Embodiments of the present invention provide isolation of the body voltage from ground during ESD and less body bounce during regular operation. A typical switching pattern for a high performance FPGA will have IOs toggling at around 1 GHz with fronts as short as approximately 100 psec. An IO buffer implementing the ESD protection circuit 500 will exhibit significantly less body bounce than a solution that relies on a resistor connected to the base of the NPN bipolar transistor 240 to generate voltage at the body of the NPN bipolar transistor 240.

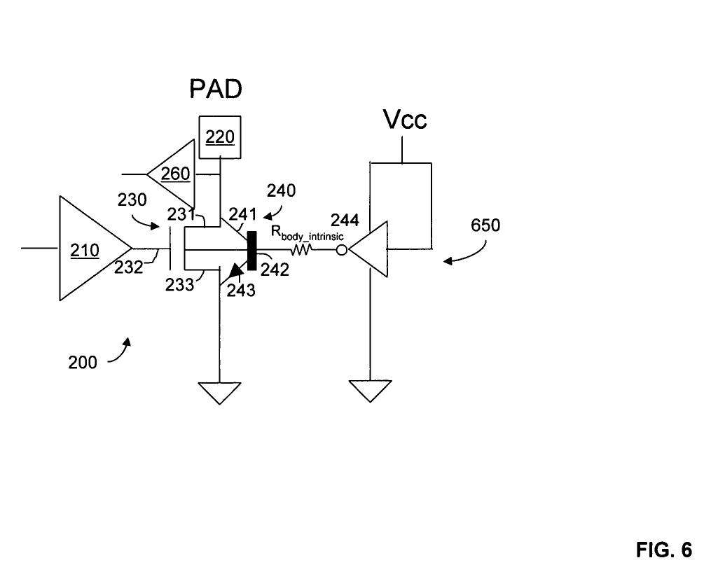

FIG. 6 illustrates a second implementation of the ESD protection circuit of FIG. 2A according to an embodiment of the present invention. The ESD protection circuit 200 includes a regulation component 650 that is implemented using an inverter. The inverter 650 includes an input connected to power supply (Vcc) and an output connected in series with the base 242 of the NPN bipolar transistor 240. During normal operation of a device, Vcc is powered up. Since the input to the inverter 650 is connected to Vcc, the inverter 650 outputs a zero when the device is on. This effectively provides a connection to ground for the body/base terminal 242 so that the switching behavior of the IO buffer is unaltered. An ESD event may occur when the power to the device is off and Vcc is powered down. When Vcc is zero, the inverter 650 provides an amount of additional resistance instead of a shorted connection to ground. The additional resistance allows a large voltage to be generated at the body of the NPN bipolar transistor 240.

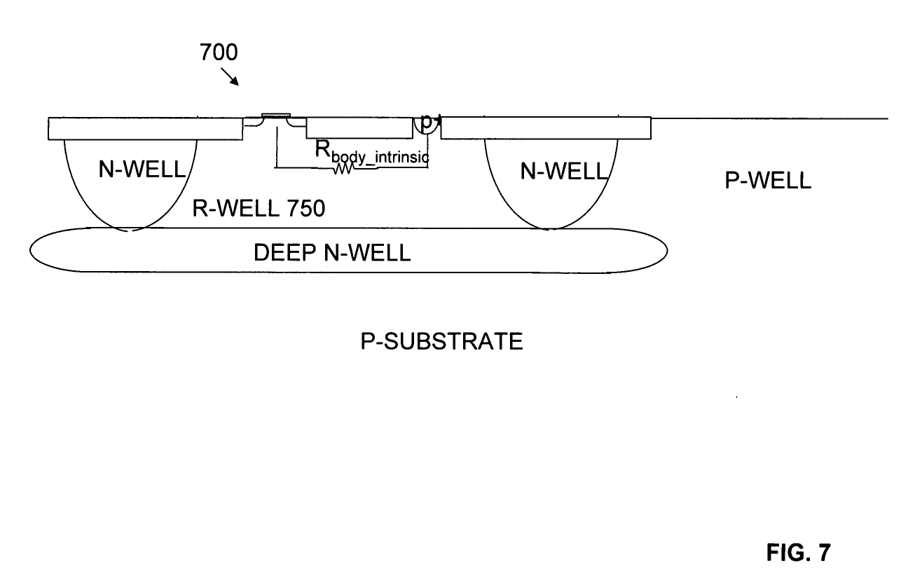

FIG. 7 illustrates an ESD protection circuit 700 implemented in an R-well according to an exemplary embodiment of the present invention. Modern CMOS technologies allow the formation of a buried or deep N-well in addition to conventional N-well pockets. An R-well may be described as a portion of the P-well that is surrounded by N type silicon. The R-well may be connected to Vcc. According to an embodiment of the present invention, the ESD protection circuit 700 is constructed in the R-well. The R-well provides improved noise immunity and better ESD performance with increased substrate resistance.

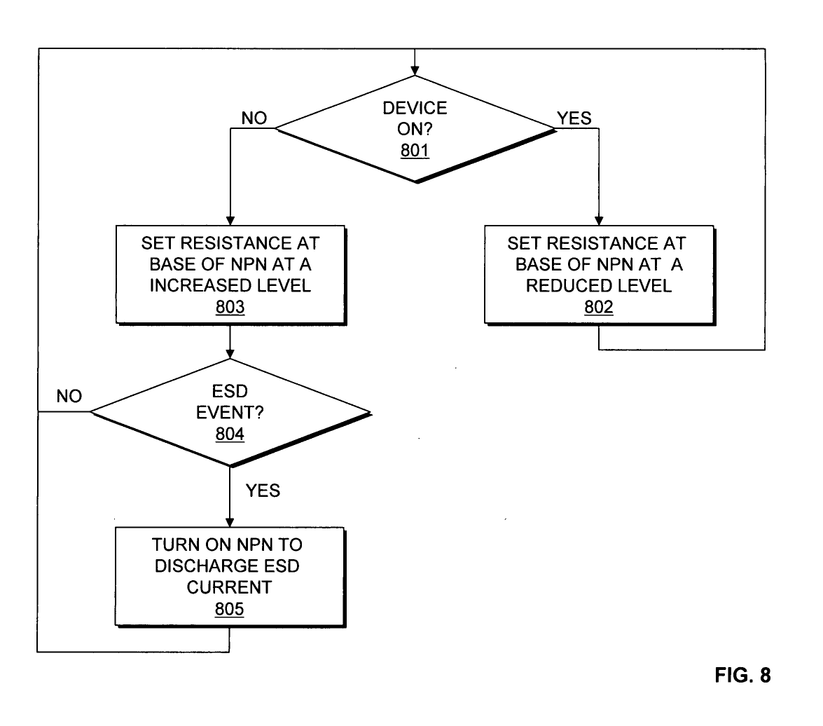

FIG. 8 is a flow chart illustrating a method for managing an ESD event according to an embodiment of the present invention. The procedures described with reference to FIG. 8 may be performed by an IO buffer that implements an ESD protection circuit such as the circuit illustrated in FIG. 2A. At 801, it is determined whether a device to be protected is on. If the device is on, control proceeds to 802. If the device is not on, control proceeds to 803.

At 802, resistance at the base of an NPN bipolar transistor is set to a reduced level. According to an embodiment of the present invention, a connection from R_{body}_{_{—}}_{intrinsic} is set to a shorted connection to ground. This allows the body voltage of the transistor to be tied to ground so that the switching behavior of the IO buffer is unaltered. Control returns to 801.

At 803, resistance at the base of the NPN bipolar transistor is set to an increased level. According to an embodiment of the present invention, a connection from R_{body}_{_{—}}_{intrinsic} is set to an open connection to ground. This provides a large amount of resistance which allows a large voltage to be generated at the body of the NPN bipolar transistor.

At 804, it is determined whether an ESD event is occurring. If an ESD event is occurring, control proceeds to 805. If an ESD event is not occurring, control returns to 801. At 805, the NPN bipolar transistor is turned on to discharge the ESD current. According to an embodiment of the present invention, a path to ground is provided from the collector to the base to the emitter of the NPN bipolar transistor.

FIG. 8 is a flow chart illustrating a method for managing an ESD event according to an embodiment of the present invention. The method may improve trigger uniformity of a snapback ESD protection device. Some of the procedures illustrated in this figure may be performed sequentially, in parallel or in an order other than that which is described. The techniques may be also be performed one or more times. It should be appreciated that not all of the techniques described are required to be performed, that additional techniques may be added, that some of the illustrated techniques may be substituted with other techniques, and other specifics may be utilized to practice the procedures described. In the foregoing specification embodiments of the invention has been described with reference to specific exemplary embodiments thereof. It will, however, be evident that various modifications and changes may be made thereto without departing from the broader spirit and scope of the embodiments of the invention. The specification and drawings are, accordingly, to be regarded in an illustrative rather than restrictive sense.

What is claimed is:

1. An electrostatic discharge (ESD) circuit for a semiconductor device, comprising:
a first transistor providing a first path from a source of an electrostatic charge to ground;
a second transistor providing a second path from the source of the electrostatic charge to ground; and
a regulation component coupled in series to a base of the second transistor to provide a first amount of resistance when the semiconductor device is off and to provide a second amount of resistance when the semiconductor device is on.

2. The apparatus of claim 1, wherein the regulation component comprises a metal oxide semiconductor field effect transistor.

3. The apparatus of claim 1, wherein the regulation component comprises a NMOS transistor having a drain coupled in series to a base of the second transistor, a gate coupled to a voltage supply of the semiconductor device (Vcc), and a source coupled to ground.

4. The apparatus of claim 3, wherein the voltage supply of the semiconductor device powers a large power domain.

5. The apparatus of claim 3, wherein the voltage supply of the semiconductor device powers a largest number of circuits on a chip which the semiconductor device resides on.

6. The apparatus of claim 2, wherein the first transistor is a thin oxide transistor.

7. The apparatus of claim 1, wherein the regulation component comprises an inverter.

8. The apparatus of claim 1, wherein the regulation component comprises an inverter with its input coupled to a power supply (Vcc) and its output coupled in series to a base of the second transistor.

9. The apparatus of claim 1, wherein the amount of resistance provided operates to generate a voltage level between the base and emitter of the second transistor during an ESD event to switch the second transistor on.

10. The apparatus of claim 1, wherein the first amount of resistance provided is within the magnitude of at least 1 kΩ.

11. The apparatus of claim 1, wherein the second amount of resistance provided is a negligible resistance.

12. The apparatus of claim 1, wherein the second amount of resistance provided is within the magnitude of at most 20Ω.

13. The apparatus of claim 1, wherein the second amount of resistance is less than the first amount of resistance.

14. The apparatus of claim 1, wherein the source of the electrostatic charge is from a pad of an IO buffer.

15. The apparatus of claim 1, wherein the first transistor and the second transistor may be implemented with an array of transistors.

16. The apparatus of claim 1, wherein the ESD circuit is implemented in an R-well.

17. The apparatus of claim 16, wherein the R-well includes a portion of a P-well that is surrounded by N type silicon.

18. The apparatus of claim 1, wherein the first transistor comprises a metal oxide semiconductor field effect transistor.

19. The apparatus of claim 1, wherein the second transistor comprises a NPN bipolar transistor.

20. An electrostatic discharge (ESD) protection circuit for a semiconductor device, comprising:
an array of metal oxide semiconductor field effect transistors (MOSFETs) and NPN bipolar transistors, each of the MOSFETs and NPN transistors providing a first path and second path from a source of an electrostatic charge to ground; and
a regulation component coupled to a base/body contact of the NPN bipolar transistor to provide an amount of resistance when the semiconductor device is off and to provide a reduced amount of resistance when the semiconductor device is on.

21. The apparatus of claim 20, wherein the regulation components comprises a NMOS transistor having a drain coupled in series to a base of the NPN bipolar transistor, a gate coupled to a voltage supply of the semiconductor device (Vcc), and a source coupled to ground.

22. The apparatus of claim 20, further comprising a plurality of first ballast resistors, each of the plurality of first ballast resistors connected in series with a drain of one of the MOSFETs, and a plurality of second ballast resistors, each of the plurality of second ballast resistors connected in series with a source of the one of the MOSFETs to facilitate even distribution of ESD current among the array of transistors.

23. The apparatus of claim 20, wherein the amount of resistance provided operates to generate a voltage level between the base and emitter of the NPN bipolar transistors during an ESD event to switch the NPN bipolar transistors on.

24. The apparatus of claim 20, wherein the reduced amount of resistance provided is a negligible resistance.

25. An electrostatic discharge (ESD) circuit coupled to an IO buffer, the circuit including a discharge transistor, a parasitic transistor and a regulation component, wherein the discharge transistor is coupled to provide a first discharge path for the IO buffer when an ESD event is occurring and wherein the regulation component is coupled to force the parasitic transistor to provide a second discharge path for the IO buffer when the ESD event is occurring and to prevent the parasitic transistor from degrading regular operation of the IO buffer.

26. The apparatus of claim 25, wherein the discharge transistor comprises a metal oxide semiconductor field effect transistor.

27. The apparatus of claim 25, wherein the parasitic transistor comprises a NPN bipolar transistor.

28. The apparatus of claim 25, wherein the first and second discharge paths lead to ground.

29. The apparatus of claim 25, wherein the regulation component prevents the parasitic transistor from degrading regular operation of the IO buffer by limiting a voltage drop across the emitter of the parasitic transistor to a negligible amount.

30. The apparatus of claim 25, wherein the regulation component prevents the parasitic transistor from degrading regular operation of the IO buffer by providing a path with negligible resistance from the base of the parasitic transistor to ground.

31. The apparatus of claim 25, wherein the regulation component forces the parasitic transistor to provide the second discharge path by providing a high impedance path from the base of the parasitic transistor to ground.
